(19) United States
(12) Patent Application Publication
(10) Pub. No.: US 2008/0240677 A1
(43) Pub. Date: Oct. 2, 2008

(54) Playback apparatus, broadcast receiving device, and computer-readable recording medium

(75) Inventor: Akira Watanabe, Hanno-shi (JP)

Correspondence Address: COHEN, PONTANI, LIEBERMAN & PAVANE LLP, 551 FIFTH AVENUE, SUITE 1210, NEW YORK, NY, 10176, US

(73) Assignee: Casio Hitachi Mobile Communications Co., Ltd., Tokyo (JP)

(21) Appl. No.: 12/077,390

(22) Filed: Mar. 19, 2008

(30) Foreign Application Priority Data
Mar. 29, 2007 (JP) 2007-087053

(51) Int. Cl. H04N 5/91

(52) U.S. Cl. 386/68; 386/95; 386/E05.001

(57) ABSTRACT

A television broadcast received by a television broadcast receiving device is recorded as a recording file, and a central control device identifies specific recording portions (for example, commercial portions) within the recording file, and then calculates the remaining playback time (the total remaining time without the specific recording portions) that is the playback time of the recording file after the playback position minus the total time for the specific recording portions after the playback position, and displays information according to the total remaining time without the specific recording portions.

### BACKGROUND OF THE INVENTION

1. Field of the Invention

The present invention relates to a playback apparatus for playing back a broadcast that has been recorded, to a broadcast receiving device that records and plays back a broadcast that has been received, and to a computer-readable recording medium whereon is recorded a program for playing back a broadcast that has been recorded.

2. Description of Related Art

In recent years, mobile telephone devices have been provided with functions for telephone communications, functions for connecting to the Internet, functions for receiving radio broadcasts, functions for receiving television broadcasts, and functions for recording broadcasts that have been received (video and audio). In some cases when using these types of mobile telephone devices to play back a recorded radio broadcast or a television broadcast, the user may wish to know the remaining playback time, or the time at which the playback will be completed.

Given this, there are known technologies by which to discover and display the remaining playback time while playing back the audiovisual contents. (For example, see Unexamined Japanese Patent Application KOKAI Publication No. 2002-150691.)

However, when playing back a recorded radio broadcast or a television broadcast, often the playback is performed by fast-forwarding through the commercial portions, for example (hereinafter termed “skip playback”).

In the prior art described above, the remaining playback time includes the time of the commercial portions; therefore the prior art technique exhibits inability to let a user be aware of the actual playback time when the commercial portion is skip-played back. Further, there may be a large difference between the remaining playback time and the actual playback time when the skip playback is performed for the commercial portions.

Similar problems are encountered when an opening part or an ending part, or any user-designated part is skipped.

### SUMMARY OF THE INVENTION

The present invention is made in view of the above-described circumstances, and seeks to allow a user to know a playback time when a skip playback is performed in the case where the contents include a predetermined part that is to be skip-played back.

To resolve the above-described problem, the playback apparatus of the present invention comprises:

recording means storing a file to which identification information is assigned;

acquisition means for acquiring a playback time needed for playing back every part, except for a part having a predetermined content, of a content contained in the file stored in the recording means; and

display means for displaying, in a pair with the identification information, the playback time needed for playing back every part, except for the part having the predetermined content, of the contents.

As described above, the present invention makes it possible to know the actual remaining playback time, during playback, even when the recorded broadcast contains portions that will be subjected to skip playback.

### BRIEF DESCRIPTION OF THE DRAWINGS

These objects and other objects and advantages of the present invention will become more apparent upon reading of the following detailed description and the accompanying drawings in which:

FIG. 1 is a block diagram illustrating a mobile telephone device according to one embodiment of the present invention.

FIG. 2 is a flowchart illustrating one example of a process for recording a television broadcast.

FIG. 3 is a diagram illustrating one example of header information of a recording file.

FIG. 4 is a diagram illustrating a recording file over time.

FIG. 5 is a flowchart illustrating one example of a process that is executed when an operation for displaying a list of recording files is inputted.

FIG. 6 is a diagram illustrating one example of an icon table INT.

FIG. 7 is a diagram illustrating one example of a list of recording files.

FIG. 8 is a flowchart that is a continuation of FIG. 5, illustrating the process for playing back a recording file at 1× speed.

FIG. 9 is a flowchart that is a continuation of FIG. 8.

FIG. 10 is a diagram illustrating one example of a playback screen whereon is displayed the total remaining fast-forward playback time and the total remaining time without commercials.

FIG. 11 is a flowchart that is a continuation of FIG. 5, illustrating the process for skip playback of a recording file.

FIG. 12 is a diagram illustrating one example of a color table CRT.

FIG. 13 is a diagram illustrating one example of a playback screen that displays a color bar and the playback completion time.

### DETAILED DESCRIPTION OF THE PREFERRED EMBODIMENT

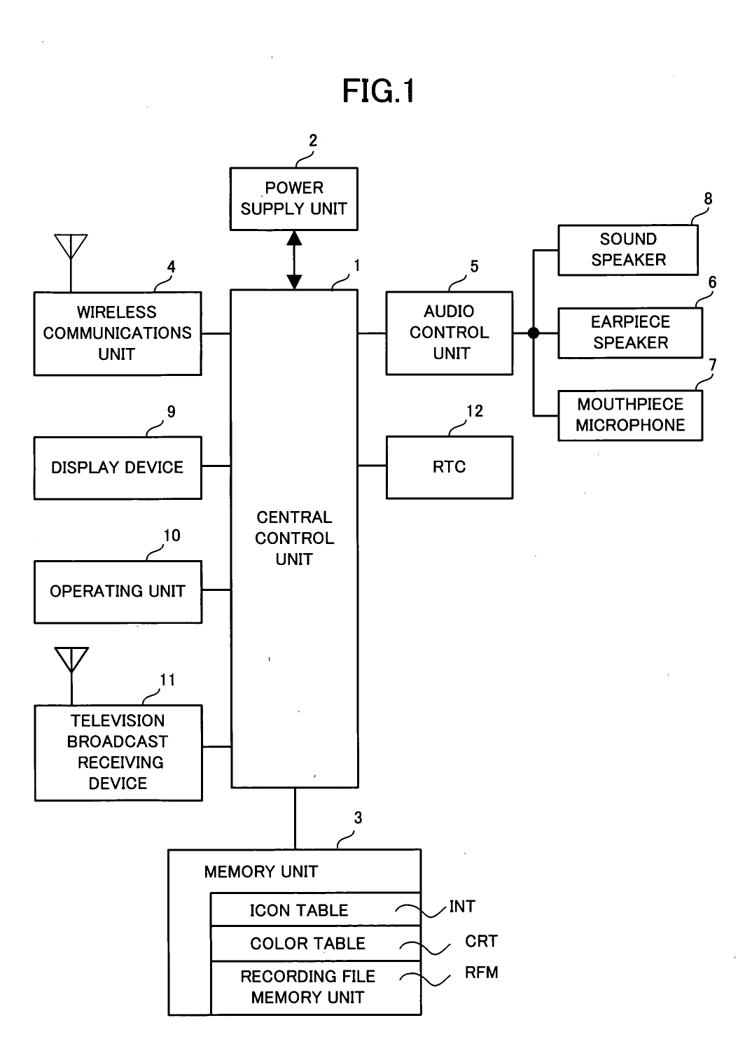

Preferred embodiment of the present invention will be described below in reference to FIG. 1 through FIG. 13.

The mobile telephone device according to one embodiment of the present invention comprises, as shown in FIG. 1, a central control unit 1, a power supply unit 2, a memory unit 3, a wireless communications unit 4, an audio control unit 5, an earpiece speaker 6, a mouthpiece microphone 7, a sound speaker 8, a display device 9, an operating unit 10, a television broadcast receiving device 11, and an RTC (real-time clock module) 12.

This mobile telephone device is provided with functions for telephone communication, functions for connecting to the Internet, functions for receiving television broadcasts, functions for recording television broadcasts (including recording audio, both here and below), and functions for playing back recorded television broadcasts.

The central control unit 1 executes various programs recorded in the memory unit 3 to perform overall control of the mobile telephone device.

The power supply unit 2 is provided with a rechargeable battery, and provides power to the rest of the mobile telephone device.

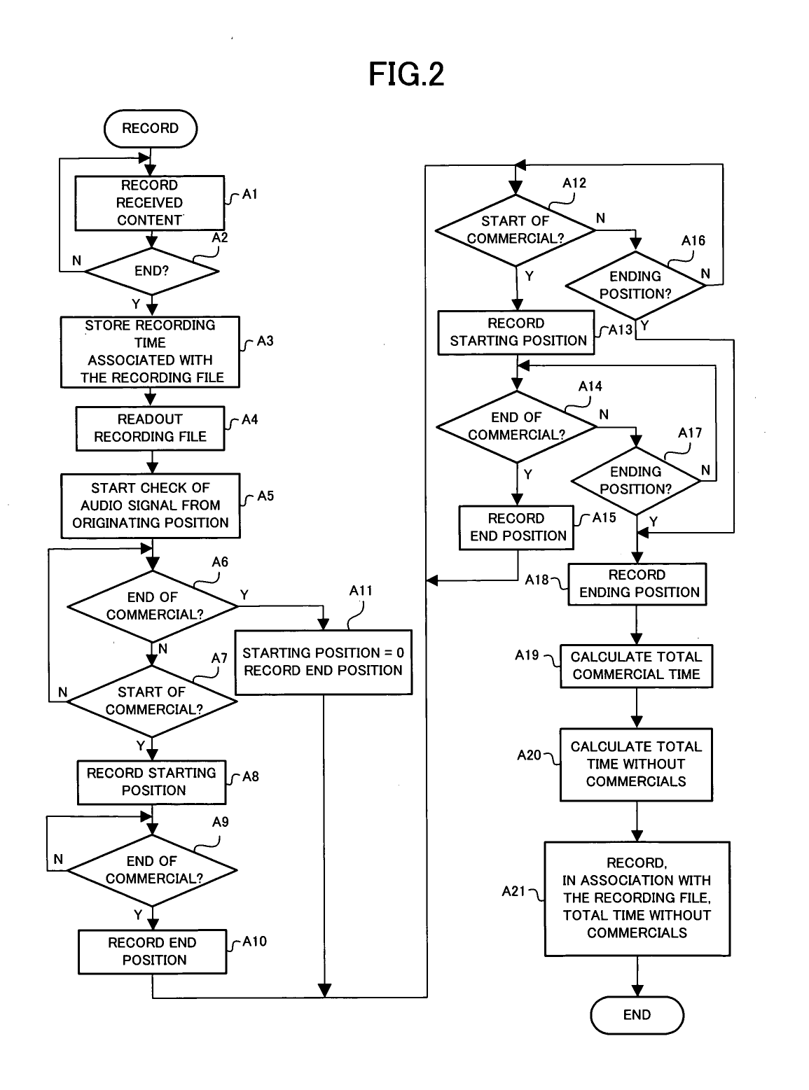

The memory unit 3 comprises a ROM (read-only memory), a RAM (random access memory) and a flash memory. The memory unit 3 stores, in a program area, programs for executing the processes illustrated in FIG. 2 through FIG. 13, described below. The mobile telephone device according to the present embodiment can use an Internet connecting function to obtain these programs. Additionally, the memory unit 3 stores, in an information area, an icon table INT, a color table CRT, and a recording file memory unit RFM, described below.

The wireless communications unit 4 receives a high-frequency signal from the receiving side of a transceiver unit that is connected to an antenna, and demodulates the signal into a base band signal.

The audio control unit 5 outputs audio to the earpiece speaker 6 and the sound speaker 8, and inputs audio from the mouthpiece microphone 7. The audio control unit 5 converts the demodulated base band signal into an analog audio signal, and outputs this audio to the earpiece speaker. The audio control unit 5 also converts into a digital base band signal the analog audio that is inputted into the mouthpiece microphone 7.

The wireless communications unit 4 applies this base band signal to the transmitter side of the transceiver unit, and sends it from the antenna.

The display device 9 has, for example, a liquid crystal display, and displays display information received via the Internet-connecting function, and television broadcast video. The operating unit 10 has various operating keys and a pointing device and includes as operating keys, for example, a Receive key for turning ON/OFF the function for receiving television broadcasts, a Record key for turning ON/OFF the function for recording television broadcasts, and a Playback key for turning ON/OFF the function for playing back recorded television broadcasts. Via the operating unit 10, for example, are input the telephone numbers, text, and commands.

The central control unit 1 executes processes specified by operations inputted via the operating unit 10.

The television broadcast receiving device 11 receives television broadcasts for mobile receivers. The television broadcast receiving device 11 can receive an electronic program guide (EPG). The television broadcast receiving device 11 is connected to a television antenna, demodulates a received television broadcast signal, separates the signal into video, audio, and text information, outputs the video and text information to the display device 9, and outputs the audio to the sound speaker 8.

The RTC 12 includes a clock, and outputs the current time. The central control unit 1 receives the current time from the RTC 12.

When there is an instruction to start the recording of a television broadcast, the central control unit 1 starts recording the television broadcast received by the television broadcast receiving device 11, and starts measuring the recording time. When there is an instruction to end the recording, a recording file is produced and stored in the recording file memory unit RFM. At this time, the commercial portions within the recording file are identified, as described below, and information on the positions that indicate the ranges of the commercial portions is stored in association with the recording file. At this time, the central control unit 1 calculates and stores the remaining playback time (the total time without commercials) that is the total recording time of the recording file (the file recording time) minus the total time for the commercial portions.

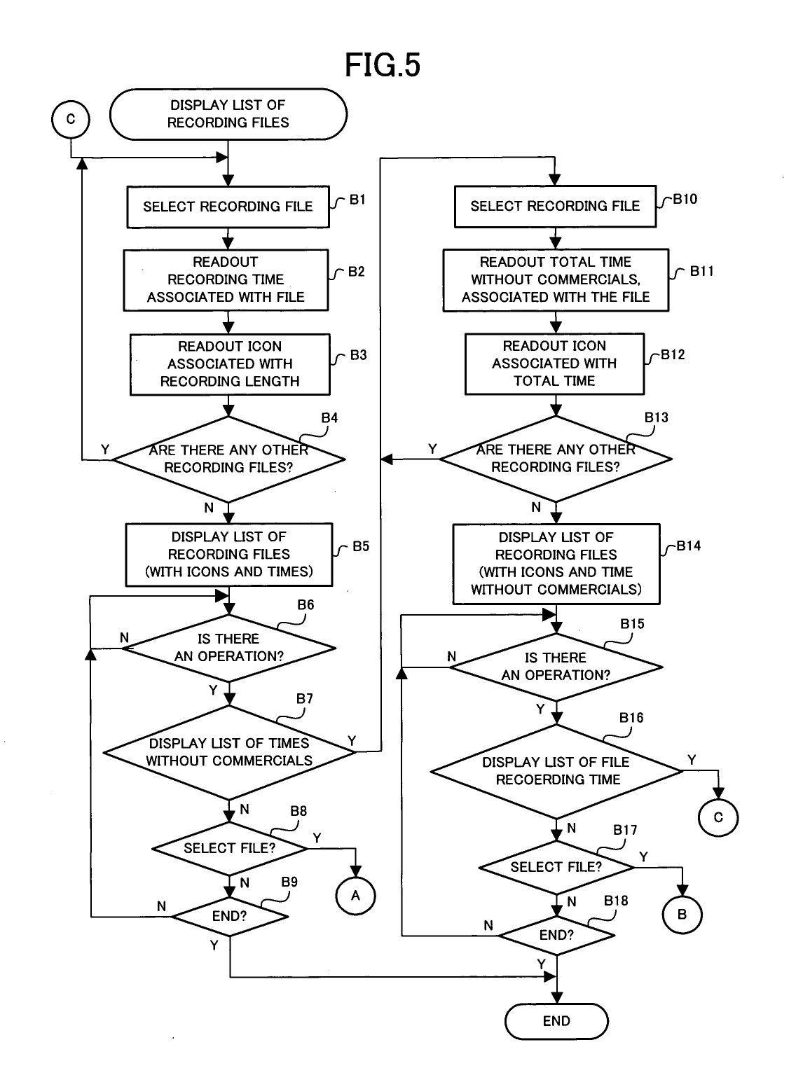

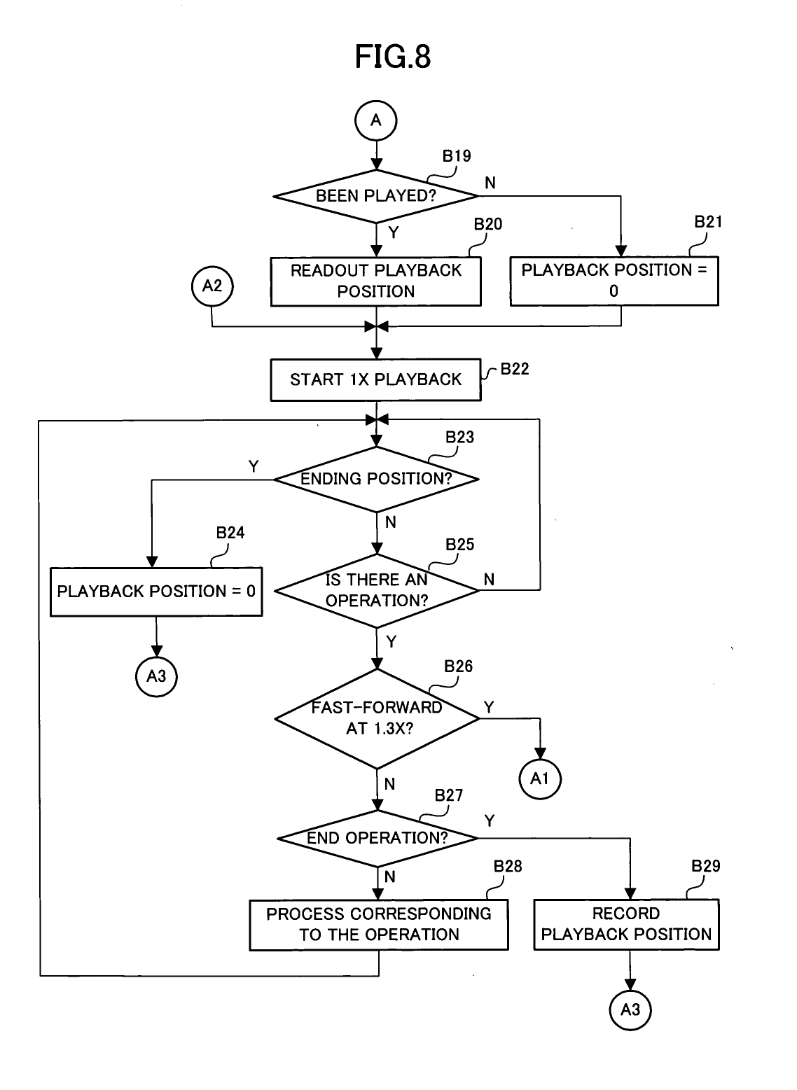

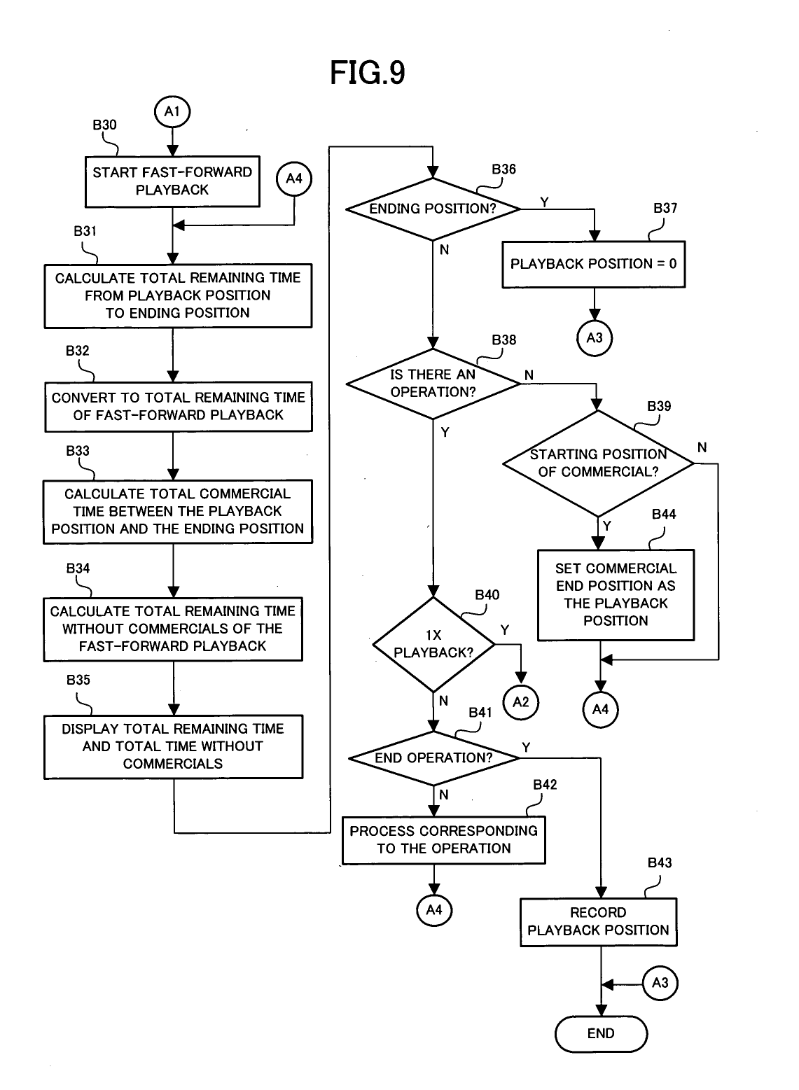

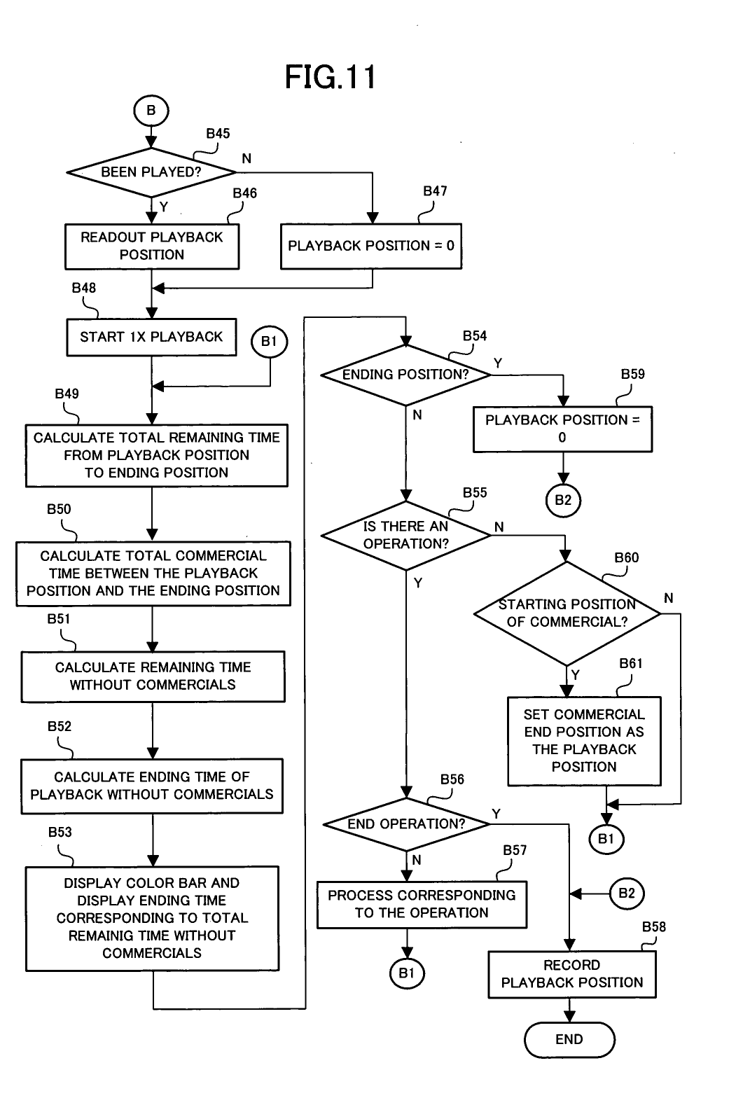

Next, the processes in the mobile telephone device according to the present embodiment will be explained in reference to the flowcharts illustrated in FIG. 2, FIG. 5, FIG. 8, FIG. 9, and FIG. 11.

Note that FIG. 2, FIG. 5, FIG. 8, FIG. 9, and FIG. 11 are flowcharts illustrating those processes, of the processes in the portable telephone device as a whole, that are the portions that are unique to the present embodiment.

FIG. 2 is a flowchart illustrating one example of a process for recording a television broadcast.

When there is an operation inputted via the operating unit 10 to start recording a television broadcast, or the start time scheduled for recording in advance comes, the central control unit 1 starts recording, to the memory unit 3, the television broadcast received by the television broadcast receiving device 11, and starts measuring the recording time (Step A1). During recording video, the central control unit 1 records, along with the video, information for calculating the elapsed time from the first frame to each frame when it is played.

Following this, the central control unit 1 determines whether or not there has been an instruction to stop recording through an operation inputted via the operating unit 10 or through a schedule for stopping wherein the recording stop time was specified in advance (Step A2). Processing returns to Step A1 and the central control unit 1 continues recording, until there is an instruction to stop recording (Step A2: No).

When there is an instruction to stop recording (Step A2: Yes), the central control unit 1 generates a recording file which the central control unit 1 stores to the recording file memory unit RFM, at which time the overall recording time, associated with the recording file, is included in header information of the recording file as the “file recording time,” and stored (Step A3).

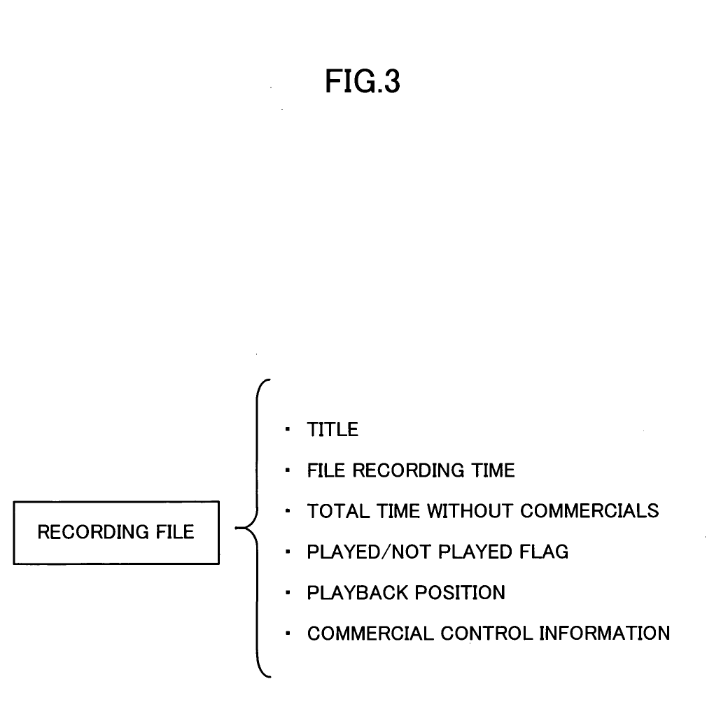

The header information of the recording file, as shown in FIG. 3, contains the “Title,” “File recording time,” “Total time without commercials,” “Played/not played flag,” “Playback position,” and “Commercial control information.”

The “Played/not played flag” indicates whether or not the recording file has been played.

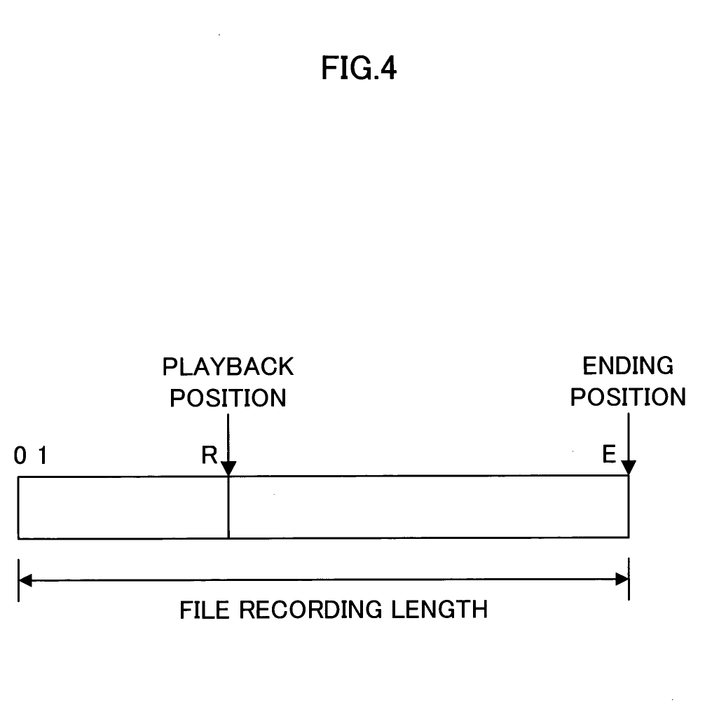

The “Playback position” indicates the final playback position the last time the recording file was played. As shown in FIG. 4, here “0” indicates the beginning position of the recording file,” “E” indicates the ending position of the recording file,” and “R” indicates the final playback position the last time the recording file was played.

The “Commercial control information” is, for each commercial portion, the elapsed time from the beginning position of the recording file until the start position of the commercial, and the elapsed time from the beginning position of the recording file until the end position of the commercial. When there is a plurality of commercials in the recording file, then the “Commercial control information” includes, for each individual commercial, the elapsed time from the beginning position of the recording file until the start position of that commercial, and the elapsed time from the beginning position of the recording file until the end position of that commercial.

When the recording has been completed, the central control unit 1 sequentially specifies the commercial portions that are included in the recording file that has been generated, and stores, for each commercial portion, information indicating the scope thereof (the start position and end position). First, the recording file is read out (Step A4), the audio signal is checked while updating the position sequentially from the beginning position (Step A5), and a determination is performed as to whether or not the commercial portion has been completed (Step A6). For example, if the audio signal switches from stereo to monaural, or switches from a bilingual broadcast to an audio multiplexed broadcast, it can be determined that the broadcast of a commercial has ended. If the commercial portion has not ended (Step A6: No), then a determination is made, based on the audio signal, as to whether or not a broadcast of a commercial has started (Step A7).

For example, in the reverse of the case wherein the commercial portion has ended, if the audio signal switches from monaural to stereo, or switches from a bilingual broadcast to an audio multiplexed broadcast, it can be determined that the broadcast of a commercial has started. Here processing returns to Step A6 if no commercial portion has started (Step A7: No).

There are some television broadcasts wherein a commercial is broadcasted prior to the start of the actual program. In this case, rather than detecting the start of the commercial portion, the central control unit 1 detects the end of the commercial portion (Step A6: Yes), and sets to “0” the information indicating the start position of the commercial portion, and records, as the information indicating the end position of the commercial portion, the elapsed time from the beginning position of the recording file until the current position (the end position). Additionally, when the start of a commercial portion is detected (Step A7: Yes), after recording the elapsed time from the beginning position of the recording file until the current position (the start position of the commercial) (Step A8), the central control unit 1 waits for the end of that commercial portion (Step A9). When the end of a commercial portion is detected (Step A9: Yes), the elapsed time from the beginning position of the recording file until the current position (the end position) is recorded (Step A10).

After this, similarly, the central control unit 1 checks whether or not a start of a commercial portion has been detected (Step A12) and whether or not the ending position of the recording file has been detected (Step A16), while reading out the recording file sequentially in order to specify sequentially the commercial portions included in the recording file. At this point, when the start of the next commercial portion is detected (Step A12: Yes), the elapsed time from the beginning position of the recording file until the current position is recorded as the start position (Step A13). Additionally, the central control unit 1 checks whether or not the end of the commercial portion has been detected (Step A14) and whether or not the ending position of the recording file has been detected (Step A17). At this point, if the end of a commercial portion is detected (Step A14: Yes), the elapsed time from the beginning position of the recording file until the current position is recorded as the end position (Step A15). Then the process goes back to step A12.

Here, when the ending position of the recording file is detected (Step A16: Yes or Step A17: Yes), the elapsed time from the beginning position of the recording file until the current position is recorded as the ending position (Step A18). The result is that each time there is a commercial portion included in the recording file, the elapsed times until the start positions and the elapsed times until the end positions are recorded sequentially in the recording file memory unit RFM. Moreover, the difference between the elapsed time of the end position and the elapsed time of the start position is calculated for each commercial portion to calculate the time for each commercial portion, and the total time for all of the commercial portions is calculated through taking a sum of the times for each of the individual commercial portions (Step A19). The “File recording time” for the recording file is read out from the recording file memory unit RFM, and the “Total time for all commercial portions” is subtracted from the “File recording time,” and the calculation result is defined as the “Total time without commercials” (Step A20). The central control unit 1 associates this with the recording file and store this to the recording file memory unit RFM (Step A21).

When an operation to display a list of the recording files has been inputted into the operating unit 10, then, as shown in FIG. 5, the central control unit 1 selects one of the recording files from the recording files stored in the recording file memory unit RFM (Step B1) and reads out the “File recording time” associated therewith (Step B2). Then the central control unit 1 reads out the icon corresponding to the “File recording time” from the icon table INT (Step B3).

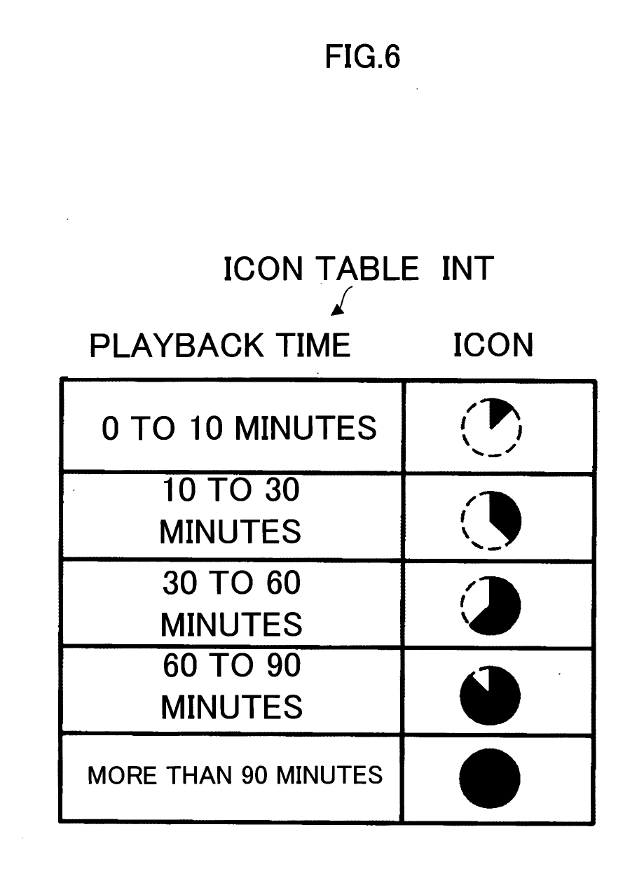

As is shown in FIG. 6, in this icon table INT, circle graph-type icons wherein the time can be understood intuitively are assigned corresponding to a playback time of “0 to 10 minutes,” a playback time of “10 to 30 minutes,” a playback time of “30 to 60 minutes,” a playback time of “60 to 90 minutes,” and a playback time of “More than 90 minutes.”

Additionally, the central control unit 1 determines whether or not there is a recording file that has not been selected (Step B4), and if there is a recording file that has not been selected, processing returns to Step B1, and a recording file is selected from among the recording files that are stored in the recording file memory unit RFM that have not been selected (Step B1). The central control unit 1 reads out the “File recording time” that is associated with the newly selected file, and reads out the icon corresponding to this “File recording time” (Step B2, B3). After this, the process described above is repeated until the selection of all of the recording files has been completed. When the selection of all of the recording files has been completed in this way (Step B4: No), the central control unit 1 displays a list of the recording files, including icons (Step B5). Note that an icon graphically indicating the “File recording time,” along with the “Title,” and the “File recording time” are displayed for each recording file in the screen listing the recording files.

If an operation is inputted via the operating unit 10 in the state wherein this screen listing the recording files (File Recording Time) is displayed (Step B6: Yes), the central control unit 1 determines if the operation has been inputted for displaying a list of the “Total time without commercials” (Step B7), if the operation has been inputted for selecting a recording file (Step B8), or if the operation has been inputted for ending the display of the list of recording files (Step B9).

If the operation is for ending the display of the list of recording files (Step B9: Yes), then the central control unit 1 ends the flow of FIG. 5.

If the operation is for displaying a list of the “Total time without commercials” (Step B7: Yes), then the central control unit 1 displays the list.

First, the central control unit 1 selects a recording file (Step B10), and reads out from the recording file memory unit RFM the “Total time without commercials” associated therewith (Step B11). The central control unit 1 reads out the icon corresponding to the “Total time without commercials” from the icon table INT.

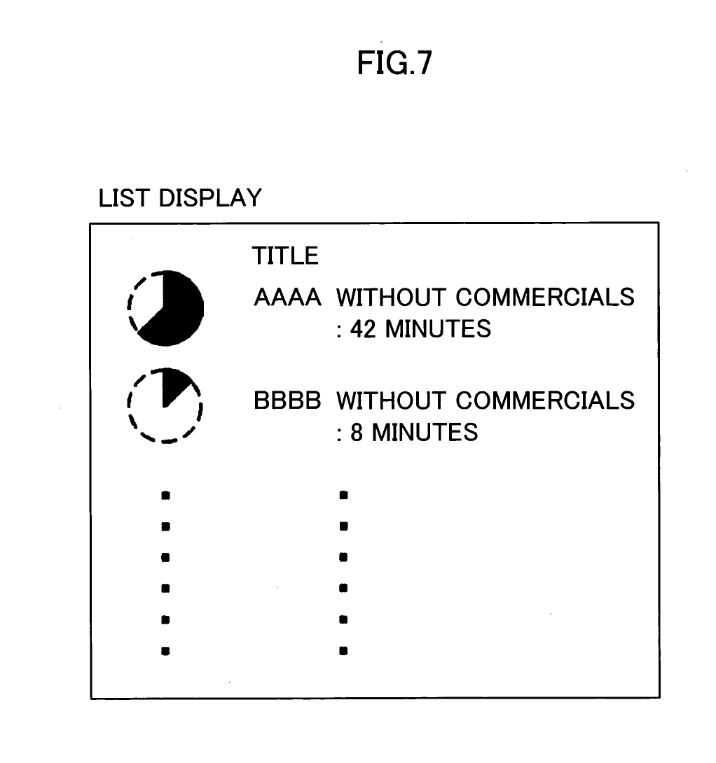

Additionally, the central control unit 1 determines whether or not there is a recording file that has not been selected (Step B13), and if there is a recording file that has not been selected, processing returns to Step B10, and a recording file is selected from among the recording files that have not been selected (Step B10). The central control unit 1 reads out, from the recording file memory RFM, the “Total time without commercials” that is associated with the newly selected recording file (Step B1), and reads out, from the icon table INT, the icon corresponding to this “Total time without commercials” (Step B12). After this, the central control unit 1 repeats the process described above until the selection of all of the recording files has been completed. When the selection of all of the recording files has been completed in this way (Step B13: No), the central control unit 1 displays a list of the recording files, including icons (Step B14) as shown in FIG. 7. For each of the recording files, this screen displays the list of an icon for graphically representing the “Total time without commercials,” along with the “Title,” and the “Total time without commercials.”

If, while the screen listing the recording files (Total Time without Commercials) is displayed, any type of operation from the operating unit 10 is inputted (Step B15: Yes), the central control unit 1 determines if the operation has been inputted for displaying the list of the File Recording Time (Step B16), if the operation has been inputted for selecting a recording file (Step B17), or if the operation has been inputted for ending the display of the list of recording files (Step B18).

If the operation is for ending the display of the list of recording files (Step B18: Yes), then the central control unit 1 ends the flow of FIG. 5. If the operation is for displaying a list of the File Recording Time (Step B16: Yes), then processing returns to Step B1, and the central control unit 1 displays the list of the File Recording Time.

If an operation is inputted to select an icon (recording file) that is displayed on the screen when in a state wherein the screen that displays the list of recording files (File Recording Time) is displayed (Step B8: Yes), then processing moves to the flow shown in FIG. 8, and the central control unit 1 plays back the selected recording file at 1× speed.

First the central control unit 1 references the “Played/not played flag” corresponding to this recording file (Step B19), and if this file has been played in the past (Step B19: Yes), then the final playback position at which the recording file was played, included in the header information for continuing the playback from the last time, is read out, and this final playback position is used as the “Playback position” in the current playback (Step B20). If this file has not been played in the past (Step B19: No), then the “Playback position” in the current playback is set to the initial value of “0” (Step B21). Then playback begins at 1× speed from this “Playback position” (Step B22).

As this playback advances, the central control unit 1 displays the playback image on the display device 9 while progressively updating the “Playback position” of the recording file, and outputs the audio from the sound speaker 8. The central control unit 1 also checks for whether or not the “Ending position” of the recording file has been reached (Step B23), and whether or not some type of operation has been inputted from the operating unit 10 (Step B25), and if there has not been any type of operation, then processing returns to Step B23, but if the “Playback position” has reached the “Ending position” (Step B23: Yes), then after the “Playback position” has been returned to the initial value “0” (Step B24), processing goes to the flow in FIG. 9, and the display of the list of recording files, and the playback thereof, are ended.

Additionally, if there is some type of operation inputted via the operating unit 10 prior to reaching the “Ending position” (Step B25: Yes), then the central control unit 1 determines if the operation has been inputted for playing back at a speed of 1.3× when compared to the playback at 1× speed (hereafter termed as fast-forward playback) (Step B26), or if the operation has been inputted for terminating the playback (Step B27). If the operation was any other operation (Step B27: No), then the process corresponding to the operation is performed (Step B28). For example, the playback may be paused (Step B28). Additionally, if the operation is to terminate the playback (Step B27: Yes), then the central control unit 1 records, as the “Playback position” in the header information, the position in the recording file that was being played back when the operation for terminating the playback was inputted (Step B29). Then processing goes to the flow in FIG. 9, and the display of the list of recording files, and the playback thereof, are ended.

Furthermore, when an operation for fast-forward playback has been inputted during 1× speed playback (Step B26: Yes), then processing goes to the flow in FIG. 9 and fast-forward playback that updates sequentially at a speed of 1.3× when compared to the playback speed of 1× is started at the “Playback position” of the recording file (Step B30). Next, the total remaining time for the playback time required from the “Playback position” to the “Ending position” is calculated during the playback (Step B31).

For example, each time the “Playback position” is updated in accordance with the progress of the playback, the “File recording time” is sequentially decremented so that that value is updated to the total remaining time when playing back at 1× speed from the “Playback position” to the “Ending position.” Next, the total remaining time when playing back with a playback speed of 1× is converted to the total remaining time when playing back with a playback speed of 1.3× (the fast-forward playback time) (Step B32).

Moreover, the central control unit 1 references the “Commercial control information” that is included in the header information, and calculates the total commercial time from the “Playback position” forward (Step B33). The “Commercial control information” is, for each commercial portion, the elapsed time from the beginning position of the recording file until the start position of the commercial, and the elapsed time from the beginning position of the recording file to the end position of the commercial. The total commercial time from the “Playback position” forward is calculated by calculating the times for each of the commercial portions that exist in the interval from the “Playback position” to the “Ending position” in the recording file, based on the “Commercial control information” (Step B33). Then the central control unit 1 converts the total commercial time for the playback at a playback speed of 1× to the total commercial time for fast-forward playback and subtracts the total commercial time for fast-forward playback from the total remaining time for fast-forward playback, calculated in Step B32, to calculate the total remaining time without commercials for fast-forward playback (Step B34).

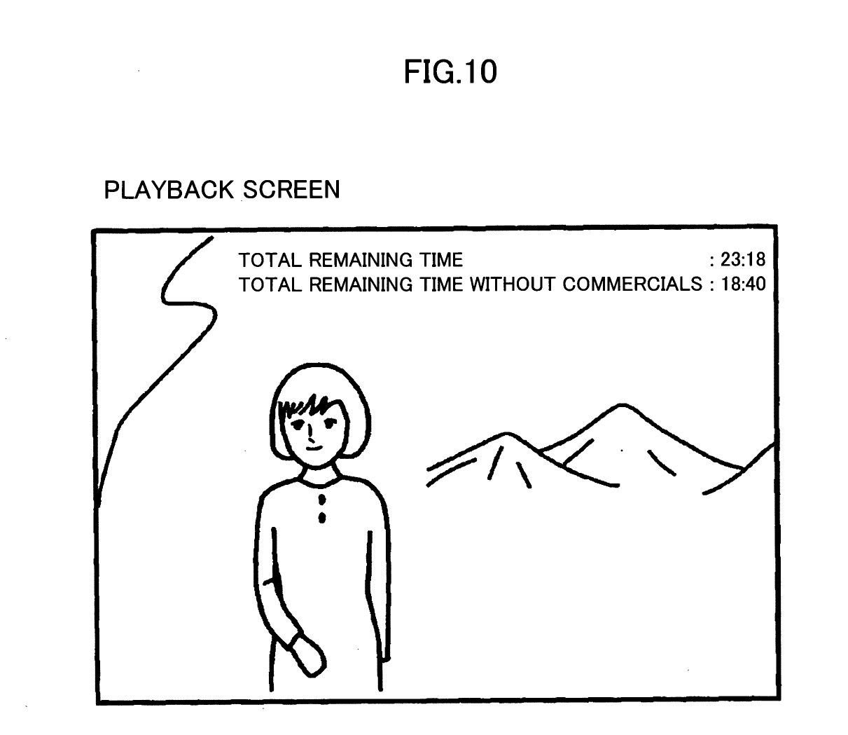

The central control unit 1, as shown in FIG. 10, displays, in the Playback screen, the fast-forward playback total remaining time and the fast-forward playback total remaining time without commercials (Step B35). In FIG. 10, “23:18” is displayed as the fast-forward playback total remaining time and “18:40” is displayed as the fast-forward total remaining time without commercials. Note that the total remaining time and the total remaining time without commercials are updated as the fast-forward playback advances. The central control unit 1 determines whether or not the current “Playback position” has reached the “Ending position” of the recording file (Step B36), whether or not some type of operation has been inputted from the operating unit 10 (Step B38), and whether or not the current “Playback position” has arrived at a commercial start position (Step B39).

If the “Playback position” has reached the “Ending position,” that is, if playback has been completed until the end of the recording file (Step B36: Yes), then the central control unit 1 returns the “Playback position” to the initial value of “0” (Step B37), and ends the display of the list of recording files and the playback thereof.

Moreover, if the current “Playback position” has reached the start position of a commercial portion (Step B39: Yes), then this commercial portion is not played back, but rather the elapsed time from the beginning position of the recording file until the end position of this commercial portion, which is included in the “commercial control information,” is set to the “Playback position” (Step B44) so as to continue the playback starting with the end position of this commercial portion. After this, processing returns to Step B31, and the total remaining time and the total remaining time without commercials are updated and displayed in the playback screen (Step B31 through B35). Each time the central control unit 1 detects the start position of a commercial, it sets, as the current “Playback position,” the end position of the commercial portion, and updates the Total remaining time and the Total remaining time without commercials in the playback screen, without playing back the commercial portion.

Moreover, if some sort of operation has been inputted from the operating unit 10 during fast-forward playback (Step B38: Yes), then the central control unit 1 determines whether or not there has been an operation to update to the 1× speed playback (Step B40), and if the operation is to update to the 1× speed playback (Step B40: Yes), processing returns to Step B22 in FIG. 8, and the fast-forward playback is updated to 1× speed playback. Additionally, when an operation for terminating the playback has been inputted (Step B41: Yes), the position in the recording file at the time that that operation is inputted is recorded as the “Playback position” (Step B43), and the display of the list of recording files, and the playback thereof, are ended. If any other operation was inputted (Step B41: No), then the process corresponding to the operation is performed (Step B42). For example, the playback is paused (Step B42), and processing returns to Step B31.

If the operation has been inputted for selecting an icon (recording file) that is displayed on the screen when the screen that displays the list of recording files (Total Remaining Time without Commercials) is displayed (Step B17: Yes), then processing moves to the flow shown in FIG. 11, and skip playback is performed for that recording file.

The central control unit 1 references the “Played/not played flag” corresponding to this recording file (Step B45), and if this file has been played in the past (Step B45: Yes), then the final playback position at which the recording file was played, included in the header information for continuing the playback from the last time, is read out, and this final playback position is used as the “Playback position” in the current playback (Step B46). If not played (Step B45: No), then the “Playback position” in the current playback is set to the initial value of “0” (Step B47). Then playback begins at 1× speed from this “Playback position” (Step B48).

The central control unit 1 displays the playback image on the display device 9 while progressively updating the “Playback position” of the recording file, and outputs the audio from the sound speaker 8. After this, as the playback progresses, the central control unit 1 calculates, as the total remaining time, the playback time required from the “Playback position” to the “Ending position” each time the “Playback position” is sequentially updated (Step B49). Additionally, the “Commercial control information” that is included in the header information is referenced to calculate the total time of the commercial portions that are included in the interval between the “Playback position” and the “Ending position” of the recording file (Step B50).

Additionally, the central control unit 1 subtracts the total commercial time from the total remaining time, calculated in Step B49, to calculate the total remaining time without commercials (Step B51). Furthermore, the central control unit 1 acquires the current time from the RTC 12 to calculate the playback ending time through adding the total remaining time without commercials to the current time (Step B52). The central control unit 1 displays the total remaining time without commercials and the playback ending time in the playback screen (Step B53). The color table CRT is referenced regarding the total remaining time without commercials, and the corresponding color bar is generated and displayed.

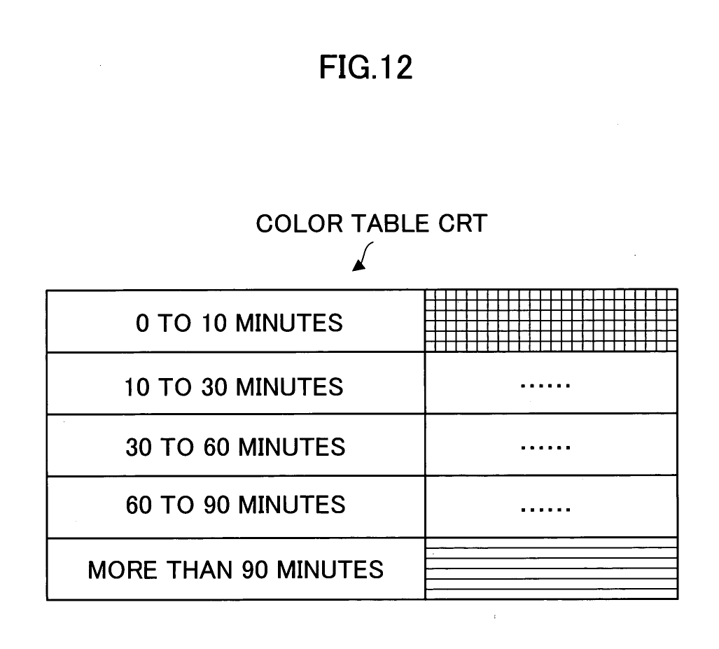

As is shown in FIG. 12, in this color table CRT, colors are assigned, whereby the time can be understood intuitively, corresponding to “0 to 10 minutes,” “10 to 30 minutes,” “30 to 60 minutes,” “60 to 90 minutes,” and “More than 90 minutes.”

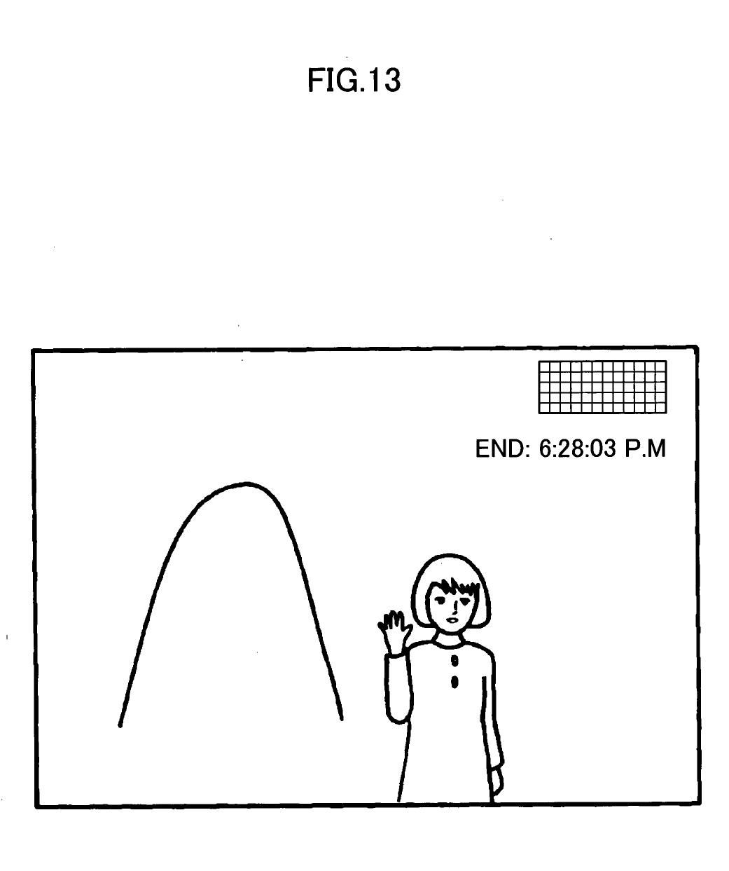

The central control unit 1 reads out the color corresponding to the “Total remaining time without commercials,” generates a color bar of that color, and, as shown in FIG. 13, displays that color bar and the playback ending time in the playback screen. In FIG. 13, a yellow color bar, indicating a “Total remaining time without commercials” of “0 to 10 minutes” is displayed as the color bar, and “6:28:03 p.m.” is displayed as the playback ending time.

The central control unit 1 determines whether or not the current “Playback position” has reached the “Ending position” of the recording file (Step B54), whether or not some type of operation has been inputted from the operating unit 10 (Step B55), and whether or not the current “Playback position” has arrived at a commercial start position (Step B60). If the “Playback position” has reached the “Ending position,” that is, if playback has been completed until the end of the recording file (Step B54: Yes), the “Playback position” is returned to the initial value of “0” (Step B59), and the display of the list of recording files and the playback thereof is ended (step B58).

Moreover, if the current “Playback position” has reached the start position of a commercial portion (Step B60: Yes), then this commercial portion is not played back, but rather the playback is continued starting with the end position of the commercial portion. To do this, the elapsed time from the beginning position of the recording file until the end position of the commercial portion, which is included in the “Commercial control information,” is set as the “Playback position” (Step B61). After this, processing returns to Step B49, and the total remaining time without commercials and the playback ending time are updated and displayed in the playback screen (Step B49 through B53). Each time the central control unit 1 detects the start position of a commercial, it sets, as the current “Playback position,” the end position of the commercial portion, and updates the Total remaining time and the Total remaining time without commercials in the playback screen, without playing back the commercial portion.

Note, that if some sort of operation has been inputted via the operating unit 10 during playback (Step B55: Yes), then if that is an operation for terminating the playback (Step 56: Yes), the position in the recording file at the time that that operation is inputted is recorded as the “Playback position” (Step B58), and the display of the list of recording files, and the playback thereof, are ended. If any other operation is inputted (Step B56: No), then the process corresponding to the operation is performed (Step B57). For example, the playback is paused (Step B57), and processing returns to Step B49.

As described above, in the present embodiment, when a television broadcast that has been received by the television broadcast receiving device 11 has been recorded in the memory unit 3 as a recording file, the central control unit 1 identifies the commercial portions within the recording file, calculates the remaining playback time (the total remaining time without commercials) that is the remaining playback time of the recording file after the playback position minus the total time for the commercial portions after the playback position therein, and displays information according to the total remaining time without commercials. Because of this, when playing back a recording file it is possible to check the actual playback time, even when commercial portions for which the playback will be skipped are included, making it possible to know whether or not the entire playback will be concluded at a desired time.

Immediately following the recording of the television broadcast, the central control unit 1 sequentially identifies the commercial portions from the beginning position of the recording file, and stores, in association with the recording file, commercial control information indicating the ranges of the commercial portions. Because the recording and the production of the commercial control information are performed independently, complex algorithms can be used in order to produce the commercial control information, making it possible to identify the commercial portions accurately.

The central control unit 1 calculates the total remaining time required for playing back the recording file after the playback position, and calculates the total commercial time that exists after the playback position. Then the total commercial time is subtracted from the total remaining time to calculate the total remaining time without commercials. Because of this, the total remaining time without commercials can be calculated accurately.

When fast-forward playback has been specified, the total remaining time without commercials (the playback time at the 1× playback speed) is converted into a total remaining time without commercials corresponding to the fast-forward playback (the playback time at the 1.3× playback speed). Because of this, the total remaining time without commercials can be calculated accurately even for fast-forward playback.

Note that the fast-forward playback speed is not limited to the 1.3× speed, but rather may be a predetermined speed that is faster than the 1× speed.

More, the method for computing the total time without commercial portion in the fast-forward playback is not limited to steps B31 to 35 shown in FIG. 9. For example, the computing, performed by the central computing unit 1, of total time may be such that, first the total time without commercial portion in 1× speed playback is obtained, and then the obtained total time is divided by 1.3.

The central control unit 1 displays the total remaining time without commercials, the playback end time that is calculated by adding to the current time the total remaining time without commercials, and a color bar by which it is possible to understand intuitively the total remaining time without commercials. Because of this, the total remaining time without commercials can be understood accurately by the user.

Additionally, in the case of skip playback, the central control unit 1 does not playback the commercial portion within the recording file, but rather skips the commercial portion during the playback, making it unnecessary to perform fast-forwarding operations, enabling skip playback to be performed easily.

In the skip playback, the central control unit 1 updates and sequentially displays the total remaining time without commercials after the playback position according to the progress of playback. Because of this, the total remaining time after the playback position can be understood accurately by the user.

The central control unit 1 displays a list of recording files, including the total remaining time without commercials. Because of this, when the user has a limited time, for example, the user will be able to know with accuracy which recording files can be viewed within the available time.

In the above-described embodiment, the central control unit 1 records an elapsed time lapsed after the first frame, for each frame included in the video; however, instead of recording the elapsed time, a serial number that assigns a sequential number for each frame, beginning with the first frame, may be recorded and when necessary, the elapsed time lapsed after the first frame may be computed based on the numbers assigned to the frames.

Note that while in the embodiment described above, when the commercial portions within the recording files are identified, the commercial portions are identified depending on changes in the audio signal, instead the commercial portions may be identified through detecting “event messages” that are added before and after the commercial portions.

While in the embodiment described above the commercial portions within the recording files are identified immediately after the recording of the television broadcast, the commercial portions may be identified depending on operations inputted via the operating units 10 instead. Moreover, the commercial portions may be identified prior to playback of the recording file, or the commercial portions may be identified during recording of the television broadcast.

Furthermore, while in the embodiment described above the total remaining time without commercials is calculated by subtracting the total time of the commercial portions from the total remaining time after the playback position, instead the playback time may be calculated as the remaining playback time after the playback position (the total remaining time without specific recording portions) by subtracting the total time of specific recording portions including the opening portion, the ending portion, and commercial portions. And the specific recording portions, which are portions other than the main program such as opening portions and ending portions, are detected based on performing image analysis or audio analysis, based on the broadcast reception times, and so forth. In this case, the opening portions and ending portions for the same program broadcasted on different weeks have identical content, so the opening portions and ending portions may be identified through determining whether or not the opening portions and ending portions are characteristically identical to that which was broadcasted the previous time.

The present invention may be applied not only to devices for recording received television broadcasts, but also to devices for recording received radio broadcasts. Moreover, the present invention may be applied not only to mobile telephone devices with broadcast receiving functions, but also to stationary broadcast receiving devices.

Furthermore, insofar as the device is a playback apparatus capable of playing back recording files wherein television broadcasts are recorded, the present invention can be applied even if there is no broadcast receiving function.

Similarly, insofar as the device is a playback apparatus capable of playing back recording files wherein radio broadcasts are recorded, the present invention can be applied even if there is no broadcast receiving function.

While an explanation is given above regarding an embodiment of the present invention, it should be understood that various changes and combinations required for ease in design and for other factors are included within the invention as described in the claims, and within the scope of the present invention corresponding to the specific example that is described in the embodiment of the invention.

Various embodiments and changes may be made thereunto without departing from the broad spirit and scope of the invention. The above-described embodiment is intended to illustrate the present invention, not to limit the scope of the present invention. The scope of the present invention is shown by the attached claims rather than the embodiment. Various modifications made within the meaning of an equivalent of the claims of the invention and within the claims are to be regarded to be in the scope of the present invention.

This application is based on Japanese Patent Application No. 2007-087053, filed on Mar. 29, 2007 including the specification, claims, drawings and summary. The disclosure thereof is all incorporated herein by reference in its entirety.

What is claimed is:

1. A playback apparatus comprising:
recording means storing a file to which identification information is assigned;
acquisition means for acquiring a playback time needed for playing back every part, except for a part having a predetermined content, of a content contained in the file stored in the recording means; and
display means for displaying, in a pair with the identification information, the playback time needed for playing back every part, except for the part having the predetermined content, of the content.

2. The playback apparatus according to claim 1, further comprising specifying means for specifying the predetermined part of the content contained in the file, wherein
the acquisition means acquires a difference between a playback time needed for playing back every part of the content contained in the file and a time needed for playing back the part specified by the specifying means.

3. The playback apparatus according to claim 1, further comprising specifying means for specifying the predetermined part of the contents contained in the file, wherein
the acquisition means acquires a difference between a playback time needed for playing back every part of the content contained in the file and a sum of playback times needed for playing back the parts specified by the specifying means.

4. The playback apparatus according to claim 1, wherein
when a plurality of files are recorded in the recording means,
the acquisition means acquires, for each of the plurality of files, a playback time needed for playing back every part, except for a part having a predetermined content, of the content of the file;
the display means displays, as a list, the acquired playback times needed for playing back every part, except for a part having a predetermined content, of the respective contents of the files and the respective identification information of the plurality of files so that each identification information is paired with the respective acquired playback time.

5. The playback apparatus according to claim 1, further comprising playback means for playing back every part, except for a part having a predetermined content, of a file stored in the recording means; wherein
the acquisition means acquires a first remaining playback time, remaining in playing back every part from a position being played back to the end of the content contained in the file, and a second remaining playback time, remaining in playing back every part, except for a part having a predetermined content, from the position being played back to the end of the contents contained in the file; and
the display means displays the first remaining playback time and the second remaining playback time.

6. The playback apparatus according to claim 5, further comprising specifying means for: (i) specifying the part having the predetermined content, of the content contained in the file, and (ii) storing a starting position and an end position of the part having the predetermined contents, in such a way as to be associated with the file, wherein
the acquisition means acquires the second remaining playback time, based on the starting and end positions of the part having the predetermined contents, during the playback of the content contained in the file, the playback being performed by the playback means.

7. The playback apparatus according to claim 1, wherein the display means displays a mark indicating the playback time, acquired by the acquisition means, of the content.

8. A broadcast receiving device comprising:
a playback apparatus as recited in claim 1;
receiving means for receiving broadcast; and
recording a file containing a content of the received broadcast to the recording means.

9. A computer-readable recording medium having recorded thereon a program to cause a computer, including recording means storing a file to which identification information is assigned, to execute the processes of:
acquiring a playback time needed for playing back every part, except for a part having a predetermined content, of a content contained in the file stored in the recording means; and
displaying, in a pair with the identification information, the playback time needed for playing back every part, except for the part having the predetermined content, of the contents.
